(19) United States
(12) Patent Application Publication
(10) Pub. No.: US 2005/0083253 A1
(43) Pub. Date: Apr. 21, 2005

(54) Panel driving method and apparatus

(76) Inventor: Seong-Chan Lee, Seoul (KR)

Correspondence Address: MCGUIREWOODS, LLP, 1750 TYSONS BLVD, SUITE 1800, MCLEAN, VA, 22102, US

(21) Appl. No.: 10/952,177

(22) Filed: Sep. 29, 2004

(30) Foreign Application Priority Data
Oct. 15, 2003 (KR) 2003-71884

(51) Int. Cl. G09G 3/28

(52) U.S. Cl. 345/60

(57) ABSTRACT

A panel driving method for maintaining constant color temperature over time, comprising determining gains for red (R), green (G), and blue (B) phosphors and adjusting input R, G, and B values using the determined gains. The gains for R, G, and B phosphors may be determined according to brightness attenuation characteristics of R, G, and B phosphors versus used time of a panel. The brightness attenuation characteristics of R, G, and B phosphors may also be obtained using a phosphor attenuation characteristic as a function of time. Alternatively, the brightness attenuation characteristics of R, G, and B phosphors may be obtained referring to stored data. The levels input to the R, G, and B phosphors are determined on the basis of an attenuation characteristic of a phosphor having a greatest attenuation rate.

This application claims the benefit of Korean Patent Application No. 2003-71884, filed on Oct. 15, 2003, which is hereby incorporated by reference for all purposes as if fully set forth herein.

### BACKGROUND OF THE INVENTION

1. Field of the Invention

The present invention relates to a display panel driving method and apparatus, and more particularly, to a panel driving technology for maintaining luminescence characteristics of phosphor.

2. Discussion of the Related Art

FIG. 1 shows a typical, three electrode surface discharge type plasma display panel (PDP). FIG. 2 illustrates an operation of a single cell of the PDP shown in FIG. 1.

Referring to FIG. 1 and FIG. 2, address electrode lines A₁, A₂, . . . , Aₘ, dielectric layers 102 and 110, Y-electrode lines Y₁, . . . , Yₙ, X-electrode lines X₁, . . . , Xₙ, phosphor layers 112, partition walls 114, and a protective layer 104, are provided between front and rear glass substrates 100 and 106 of a general surface discharge PDP 1.

The address electrode lines A₁ through Aₘ are formed on the front surface of the rear glass substrate 106 in a predetermined pattern. A rear dielectric layer 110 is formed on the surface of the rear glass substrate 106 having the address electrode lines A₁ through Aₘ. The partition walls 114 are formed on the front surface of the rear dielectric layer 110 to be parallel to the address electrode lines A₁ through Aₘ. These partition walls 114 define the discharge areas of respective display cells and serve to prevent cross talk between display cells. The phosphor layers 112 are formed between partition walls 114.

The X-electrode lines X₁ through Xₙ and the Y-electrode lines Y₁ through Yₙ are formed on the rear surface of the front glass substrate 100 orthogonally to the address electrode lines A₁ through Aₘ, and their intersections define display cells. Each of the X-electrode lines X₁ through Xₙ may include a transparent electrode line Xₙₐ formed of a transparent conductive material such as indium tin oxide (ITO), and a metal electrode line X_{nb} for increasing conductivity. Each of the Y-electrode lines Y₁ through Yₙ may also include a transparent electrode line Yₙₐ formed of a transparent conductive material and a metal electrode line Y_{nb}. A front dielectric layer 102, covering the X-electrode lines X₁ through Xₙ and the Y-electrode lines Y₁ through Yₙ is deposited on the rear surface of the front glass substrate 100. The protective layer 104, which protects the panel 1 against a strong electrical field, is deposited on the rear surface of the front dielectric layer 102. The protective layer 104 may be a MgO layer. A plasma forming gas is hermetically sealed in a discharge space 108.

In driving such a PDP, a reset step, an address step, and a sustain step may be sequentially performed in each subfield. In the reset step, charges are uniformly set in display cells to be driven. In the address step, charges are set for selected and non-selected display cells. In the sustain step, a display discharge is performed in the selected display cells. During the sustain discharge, the plasma forming gas produces plasma, which emits ultraviolet rays that excite the phosphor layers 112, thereby emitting light.

U.S. Pat. No. 5,541,618 discloses an address-display separation driving method for a PDP such as that shown in FIG. 1.

FIG. 3 shows a typical driving apparatus for the PDP 1 of FIG. 1. Referring to FIG. 3, a typical driving apparatus includes an image processor 300, a logic controller 302, an address driver 306, an X-driver 308, and a Y-driver 304. The image processor 300 converts an image signal into a digital signal to generate an internal image signal that may include 8-bit red (R) video data, 8-bit green (G) video data, 8-bit blue (B) video data, a clock signal, a horizontal synchronizing signal, and a vertical synchronizing signal. The logic controller 302 generates drive control signals S_{A}, S_{y}, and Sₓ in response to the internal image signal from the image processor 300. The address driver 306 processes the address signal S_{A} to generate a display data signal and applies that data signal to the address electrode lines. The X-driver processes the X-drive control signal Sₓ and applies the result to the X-electrode lines. The Y-driver processes the Y-drive control signal S_{Y} and applies the result to the Y-electrode lines.

FIG. 4 shows a typical address-display separation driving method with respect to the Y-electrode lines of PDP 1. Referring to FIG. 4, to realize time-division grayscale display, a unit frame may be divided into a predetermined number of subfields, e.g., 8 subfields SF1 through SF8. Additionally, each individual subfield SF1 through SF8 may be composed of reset periods (not shown), address periods, A1 through A8, and sustain periods, S1 through S8.

During the address periods A1 through A8, display data signals are applied to the address electrode lines A₁ through Am, while a scan pulse is sequentially applied to the Y-electrode lines Y₁ through Yₙ.

During the sustain periods S1 through S8, a sustain pulse is alternately applied to the Y-electrode lines Y₁ through Yₙ, and the X-electrode lines X₁ through Xₙ, thereby provoking display discharges in selected display cells.

The panel's brightness is proportional to a total length of the sustain periods S1 through S8 in a unit frame. When a unit frame forming a single image is expressed by 8 subfields and 256 grayscales, different numbers of sustain pulses may be allocated to the respective 8 subfields at a ratio of 1:2:4:8:16:32:64:128. Brightness corresponding to 133 grayscales may be obtained by addressing cells and sustaining a discharge during a first subfield SF1, a third subfield SF3, and an eighth subfield SF8.

A sustain period allocated to each subfield may vary depending upon weights, which may be applied to the subfields according to an automatic power control (APC) level. Sustain periods may also vary according to gamma characteristics or panel characteristics. For example, a grayscale level allocated to a fourth subfield SF4 may be lowered from 8 to 6 while a grayscale level allocated to the eighth subfield SF8 may be increased from 32 to 34. Additionally, the number of subfields per unit frame may vary according to design specifications.

FIG. 5 is a timing chart showing examples of driving signals used in the PDP 1 of FIG. 1. In other words, FIG. 5 illustrates driving signals applied to address electrodes A1 through Aₘ, common electrodes X, and scan electrodes Y₁ through Yₙ during a single subfield SF in an address display separation (ADS) driving method of an alternating current (AC) PDP. Referring to FIG. 5, the single subfield SFₙ includes a reset period PR, an address period PA, and a sustain period PS.

During the reset period PR, a reset pulse is applied to all of the scan electrodes Y₁ through Yₙ thereby initializing wall charges in each cell. Since the initialization is performed throughout the panel, uniform wall charges may be obtained. During the address period PA, which follows the reset period PR, a bias voltage Vₑ is applied to the common electrodes X, and scan and address electrodes of cells to be displayed are simultaneously turned on. V_{A} indicates an address voltage.

During the sustain period PS, which follows the address period PA, a sustain pulse V_{S} is alternately applied to the common electrodes X and the scan electrodes Y₁ through Yₙ. A low level voltage V_{G} is applied to the address electrodes A₁ through Aₘ.

Luminescence characteristics of phosphor used in a display panel may deteriorate over time. In particular, color temperature may decrease.

### SUMMARY OF THE INVENTION

The present invention provides a panel driving method and an apparatus for maintaining a constant color temperature in a display panel using phosphor as a luminescent material.

Additional features of the invention will be set forth in the description which follows, and in part will be apparent from the description, or may be learned by practice of the invention.

The present invention discloses a panel driving method for maintaining constant color temperature over time, comprising determining gains for red (R), green (G), and blue (B) phosphors, and adjusting input R, G, and B values using the determined gains.

The present invention also discloses a panel driving apparatus comprising a gain determiner and a gain adjustor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows the structure of a typical, three electrode surface discharge type plasma display panel (PDP).

FIG. 2 shows an operation of a single cell of the PDP of FIG. 1.

FIG. 3 shows a typical driving apparatus for the PDP 1 of FIG. 1.

FIG. 4 shows a typical address-display separation driving method with respect to Y-electrode lines of the PDP 1 of FIG. 1.

FIG. 5 is a timing chart showing examples of driving signals used in the PDP 1 of FIG. 1.

FIG. 6 shows an example of phosphor attenuation characteristics.

FIG. 7 is a block diagram of a panel driving apparatus according to an exemplary embodiment of the present invention.

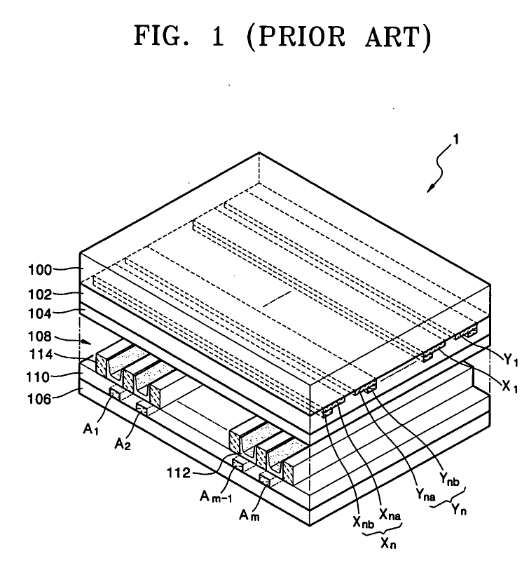

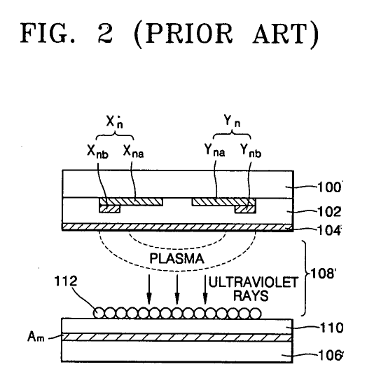

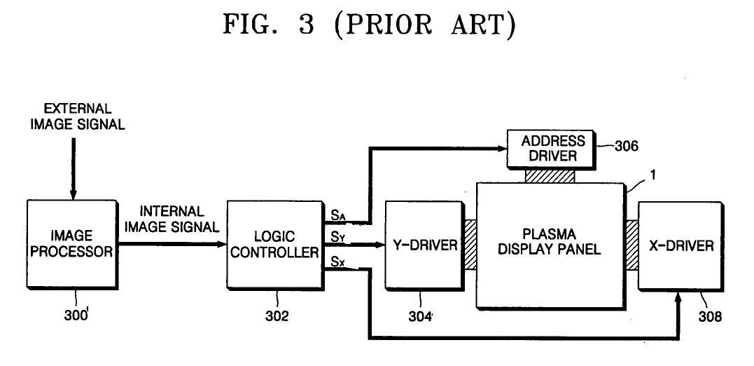

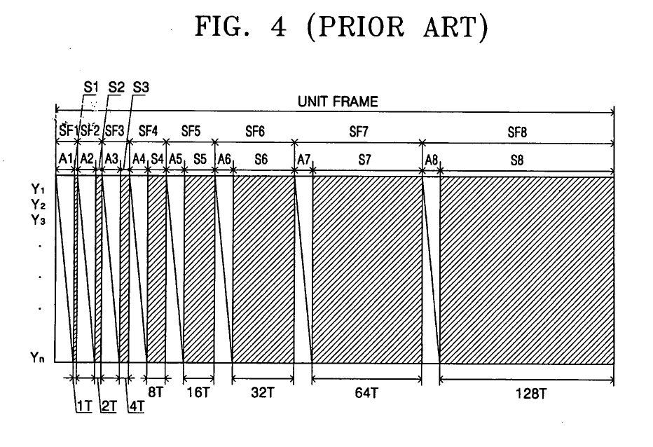

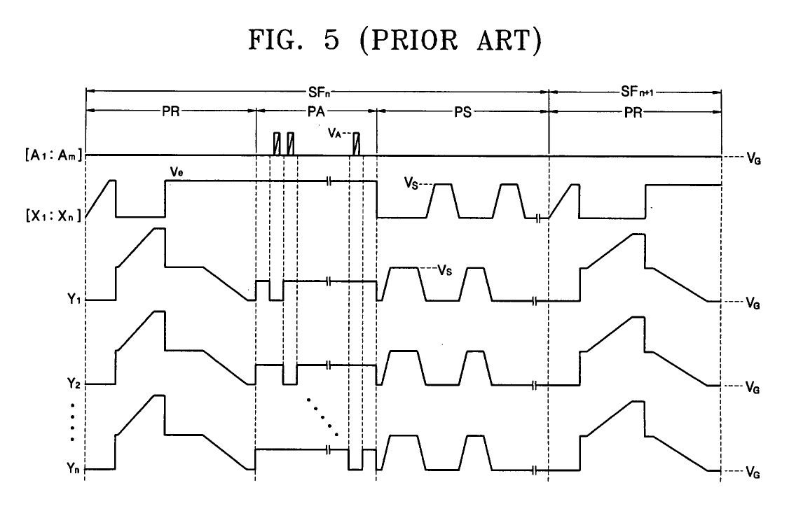

### DETAILED DESCRIPTION OF THE INVENTION

Hereinafter, preferred embodiments of the present invention will be described in detail with reference to the attached drawings.

The present invention compensates for a panel's color temperature change over time due to varying attenuation rates of its different colored phosphors e.g., red (R), green (G), and blue (B). In other words, the present invention provides a panel driving method and apparatus for maintaining the panel's initial color temperature by compensating for a change in color temperature with respect to time that the panel has been operated.

According to an exemplary embodiment of the present invention, gains for R, G, and B phosphors may be determined according to their brightness attenuation characteristics with respect to the panel's total operating time. The brightness attenuation characteristics of the R, G, and B phosphors may be obtained using a phosphor attenuation characteristic function of time. For example, they may be obtained by subtracting the product of a predetermined weight for the R, G, or B phosphor and a used time of the panel from the R, G, or B phosphors' initial brightness value. Equations (1, 2, and 3) show examples where R, G, and B phosphor attenuation characteristics are given as functions of time “t”.
R(%)=99.4−0.000331.t (1)
G(%)=95.6−0.0138.t (2)
B(%)=97.1−0.0177.t (3)

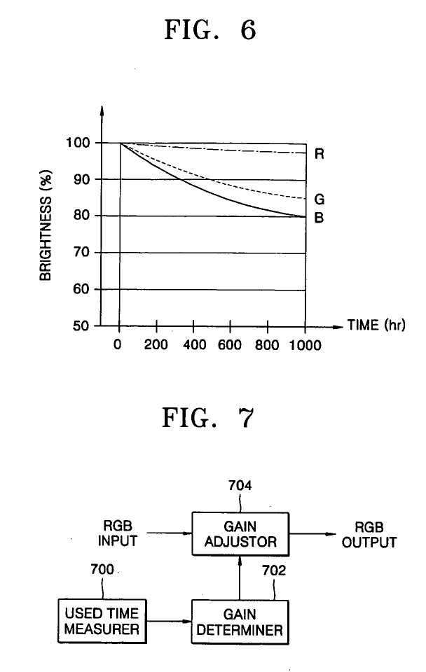

Referring to Equations (1-3), the R phosphor has the least attenuation rate, and the B phosphor has the greatest attenuation rate. FIG. 6, which does not exactly coincide with Equations (1-3), illustrates the R, G and B phosphor attenuation characteristics.

Alternatively, the R, G, and B phosphor attenuation characteristics may be obtained using a lookup table stored in memory. Table 1 shows a simplified example of such a table.

TABLE 1

| | | | Hr | 0 | 100 | 200 | 300 | 400 | 500 | 750 | 1000 |
|---|---|---|---|---|---|---|---|---|---|---|---|
| R | 100 IRE | Brightness | cd/m² | 89.1 | 88.5 | 87.9 | 88.7 | 88 | 88.3 | 87.2 | 89 |
| G | 100 IRE | Brightness | cd/m² | 164 | 154 | 149 | 148 | 145 | 144 | 140 | 137 |
| B | 100 IRE | Brightness | cd/m² | 36.1 | 34.4 | 33.3 | 32.9 | 32.3 | 31.8 | 29.9 | 29.4 |
| White | 100 IRE | Brightness | cd/m² | 83 | 79.5 | 76.2 | 76.5 | 75.1 | 72.9 | 72.2 | 72 |
| | | Color | K | 9830 | 8780 | 8400 | 8160 | 7970 | 7730 | 7240 | 7140 |
| | | temperature | | | | | | | | | |

The present invention may compensate for a color temperature (measured in kelvin (K) units) decrease with respect to used time (Hr).

Similar color temperature characteristics may be maintained when R, G, and B phosphors have the same attenuation rate. Accordingly, the color temperature characteristics may be maintained constant by compensating for R, G, and B gains on the basis of a single reference attenuation rate.

The R, G, or B attenuation characteristic, corresponding to a particular used time, may be used as a reference for gain compensation. Alternatively, a third reference other than the above-described ones may be set.

Input levels for respective R, G, and B phosphors may be determined based on attenuation characteristics of a phosphor having a greatest attenuation rate with respect to used time among the R, G, and B phosphors.

For example, in Table 1, an initial brightness ratio (i.e. at 0 hours) of the R, G, and B phosphors is 89.1:164:36.1=30.8:56.7:12.5. After 1,000 hours of use, the brightness ratio of the R, G, and B phosphors is 89:137:29.4 with respect to an input of 100 Institute of Radio Engineers (IRE). Accordingly, an attenuation gain may be determined on the basis of the B phosphor according to Equations (4 and 5).
R:B=(89.0+x):29.4=30.8:12.5 (4)
G:B=(137+y):29.4=56.7:12.5 (5)

Here, “x” and “y” indicate gains to be applied to the brightness characteristics of the R and G phosphors, respectively, on the basis of the brightness characteristic (i.e., 29.4 cd/m²) of the B phosphor. In this case, x=−16.6 cd/m² and y=−3.6 cd/m². In other words, after the panel has been used for 1,000 hours, the R phosphor brightness characteristic may be reduced by 16.6 cd/m², and the G phosphor brightness characteristic may be reduced by 3.6 cd/m².

Alternatively, an attenuation gain may be determined on the basis of the G phosphor after 1,000 hours of use according to Equations (6 and 7).
R:G=89.0+x:137=30.8 56.7 (6)
G:B=137:29.4+y=56.7:12.5 (7)

Here, “x” and “y” indicate gains to be applied to the brightness characteristics of the R and B phosphors, respectively, on the basis of the brightness characteristic (i.e., 137 cd/m²) of the G phosphor. In this case, x=−14.6 cd/m² and y=+0.8 cd/m². In other words, after 1,000 hours of use, the R phosphor brightness characteristic may be reduced by 14.6 cd/m², and the B phosphor brightness characteristic may be increased by 0.8 cd/m².

Similarly, an attenuation gain may be determined on the basis of the R phosphor after 1,000 hours of use according to Equations (8 and 9).
R:G=89.0:(137+x)=30.8:56.7 (8)
R:B=89.0:(29.4+y)=30.8:12.5 (9)

Here, “x” and “y” indicate gains to be applied to the brightness characteristics of the G and B phosphors, respectively, on the basis of the brightness characteristic (i.e., 89.0 cd/m²) of the R phosphor. In this case, x=+26.8 cd/m² and y=+6.7 cd/m². In other words, after 1,000 hours of use, the G phosphor brightness characteristic may be increased by 26.8 cd/m², and the B phosphor brightness characteristic may be increased by 6.7 cd/m².

Because the time that may be allocated to a sustain period in a single TV field is limited, gain compensation may be performed on the basis of the B phosphor, which has the greatest attenuation rate according to Equations (4 and 5), since the number of sustain pulses for each display cell including one of the R, G, and B phosphors may be adjusted.

FIG. 7 is a block diagram of a panel driving apparatus according to an exemplary embodiment of the present invention. The panel driving apparatus includes a used time measurer 700, a gain determiner 702, and a gain adjustor 704.

The used time measurer 700 measures a total period of panel operation time since the panel was initially turned on. Although not shown, the used time measurer 700 includes a real-time clock which measures a start time and an end time of each panel operation and a storage unit which accumulatively stores durations between the measured start and end times.

The gain determiner 702 determines a gain for video data of each color based on the measured total used time. Although not shown, the gain determiner 702 may include a storage unit that stores gains versus used time in the form of a lookup table so that the gain determiner 702 may determine a gain value by extracting a value corresponding to the measured total used time. Alternatively, the gain determiner 702 may determine gains using a brightness characteristic function of used time of the panel.

Here, attenuation of the R, G, and B phosphors is calculated with respect to the used time, and a gain is determined on the basis of a phosphor having greatest attenuation.

The gain adjustor 704 adjusts input R, G, and B values using gains determined by the gain determiner 702 for different colors.

As described above, according to exemplary embodiments of the present invention, color temperature of a display panel using phosphor as a luminescent material may be constant over time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A panel driving method comprising determining gains for red (R), green (G), and blue (B) phosphors according to brightness attenuation characteristics of R, G, and B phosphors versus used time of a panel.

2. The method of claim 1, wherein the brightness attenuation characteristics of R, G, and B phosphors are obtained using a phosphor attenuation characteristic function of time.

3. The method of claim 2, wherein the brightness
attenuation characteristics of R, G, and B phosphors are obtained by subtracting a product of a predetermined weight and the used time of the panel from an initial brightness value of each of the R, G, and B phosphors.

4. The method of claim 1, wherein the brightness attenuation characteristics of R, G, and B phosphors are obtained by referring to a lookup table stored in memory.

5. The method of claim 1, wherein the gains for the R, G, and B phosphors are determined on the basis of an attenuation characteristic of a phosphor having a greatest attenuation rate over the used time among the R, G, and B phosphors.

6. A panel driving apparatus comprising:
a used time measurer which measures a total used time of a panel;
a gain determiner which determines gains for input red (R), green (G), and blue (B) data according to the measured total used time; and
a gain adjustor which adjusts the input R, G, and B data using the determined gains.

7. The apparatus of claim 6, wherein the used time measurer comprises:
a real-time clock which measures a start time and an end time of each panel operation; and
a storage unit which accumulatively stores a duration between the measured start and end times.

8. The apparatus of claim 6, wherein the gain determiner comprises a storage unit which stores gains versus used time in a form of a lookup table so that the gain determiner determines a gain by extracting a value corresponding to the measured total used time from the lookup table.

9. The apparatus of claim 6, wherein the gain determiner determines the gains using a function of the measured total used time.

10. The apparatus of claim 9, wherein the function calculates attenuation of R, G, and B phosphors according to the measured total used time and determines the gains on the basis of a phosphor having greatest attenuation among the R, G, and B phosphors.
